(19) United States
(12) Patent Application Publication
(10) Pub. No.: US 2007/0217853 A1
(43) Pub. Date: Sep. 20, 2007

(54) IMAGING APPARATUS AND IMAGING METHOD

(76) Inventor: Yoshihiro KUWABARA, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/677,275

(22) Filed: Feb. 21, 2007

(30) Foreign Application Priority Data
Mar. 15, 2006 (JP) 2006-071782

(51) Int. Cl. B41J 13/10

(52) U.S. Cl. 400/624

(57) ABSTRACT

An imaging apparatus is disclosed that includes a motor that controls a drive system, a motor control unit that activates the motor based on an imaging request signal, a paper feed operations control unit that controls paper feed operations to start after a predetermined time period elapses from the activation of the motor, and a paper feed unit that performs the paper feed operations based on a paper feed operations start command signal from the paper feed operations control unit.

### BACKGROUND OF THE INVENTION

1. Field of the Invention

The present invention relates to an imaging apparatus and an imaging method.

2. Description of the Related Art

In response to improvements in image processing techniques and image forming techniques, an imaging apparatus with high processing speed as well as high resolution is being developed. The laser beam printer (LBP) is a representative example of such an imaging apparatus. The laser beam printer includes an optical scanning printer engine that forms an image using a polygon motor and a deflector to scan a laser beam. For example, the laser beam printer may be configured to write an image on a photoconductor by scanning a laser beam along the main scanning direction using a rotating deflector and changing the scanning position in the sub scanning direction each time one scan in the main scanning direction is completed.

Normally, when the laser beam printer is in standby mode, the polygon motor is at a standstill. When printing operations of the laser beam printer are started, the polygon motor starts to rotate. Actual printing on a printing medium such as paper may be enabled when the rotation speed of the polygon motor reaches a predetermined speed (steady rotation). When the polygon motor reaches a steady rotation, paper may be conveyed (fed) from a paper feed tray to a printing location where printing is to be performed so that the laser beam printer may get a first print.

It is noted that various techniques are being developed for further increasing the processing speed and resolution of the laser beam printer as is described above.

For example, Japanese Patent No. 2731042 discloses a technique for obtaining a quick first print in the laser beam printer with a simple configuration. Specifically, according to the disclosed technique, paper feed operations are started upon detecting a polygon lock signal indicating that the polygon motor, which starts rotating in response to operations of the laser beam printer, has reached a steady rotation. By starting paper feed operations based on the polygon lock signal, the start timing of paper feed operations may be flexibly adjusted according to the type of polygon motor being used as well as the extent of deterioration of the polygon motor, for example, and paper feed operations may be started as soon as the rotation of the polygon motor reaches a steady rotation so that a quick first print may be obtained.

Also, other techniques have been proposed for obtaining a quick first print such as that involving the use of a resist clutch or some other device that is capable of temporarily halting paper feed operations. FIG. 1 is a timing chart illustrating exemplary operations of a laser beam printer having a resist clutch. In a laser beam printer having a resist clutch, paper from a paper feed cassette may pass a paper feed roller that is controlled by a paper feed clutch and a resist roller that is controlled by a resist clutch to be conveyed to the printing location. In FIG. 1, the laser beam printer starts printing operations at time t0, and at time t1, the paper feed clutch is turned ON (i.e., switched from low (L) to high (H)) so that paper from the paper feed cassette passes the paper feed roller to be conveyed to the resist roller. However, since the resist clutch is still turned OFF (low) at this point, paper feed operations are temporarily halted at the resist roller. Then, when printing by the laser beam printer is enabled at time t2, the resist clutch may be turned ON (i.e., switched from low (L) to high (H)), and the paper that is temporarily halted at the resist roller may be conveyed to the printing location. By conveying the paper to the resist roller beforehand and conveying the paper from the resist roller to the printing location when printing operations are enabled, the laser beam printer with the resist clutch may be able to get a first print quicker than a printer that conveys paper from a paper feed start position such as a paper feed cassette to the printing location when printing operations are enabled.

It is noted that in the laser beam printer as disclosed in Japanese Patent No. 2731042, a detection device has to be used for detecting the point at which the polygon motor reaches a steady rotation after being activated which may lead to cost increase. Also, in a laser beam printer with a low end printer engine, a device such as a resist clutch for temporarily halting paper feed operations may not be provided for the purpose of reducing costs, for example. In this respect, there is a demand for a technique for reducing the time required for obtaining a first print in an imaging apparatus with a simple configuration.

### SUMMARY OF THE INVENTION

According to one embodiment of the present invention, an imaging apparatus is provided that includes:

a motor that controls a drive system;

a motor control unit that activates the motor based on an imaging request signal;

a paper feed operations control unit that controls paper feed operations to start after a predetermined time period elapses from the activation of the motor; and

a paper feed unit that performs the paper feed operations based on a paper feed operations start command signal from the paper feed operations control unit.

In one preferred embodiment of the present invention, the predetermined time period may correspond to a time period required for starting an imaging process after the activation of the motor.

In another preferred embodiment of the present invention, the predetermined time period may correspond to a subtracted time period obtained by subtracting a paper conveying time period from a time period required for starting an imaging process after the activation of the motor, the paper conveying time period being the required time period for conveying paper from a paper feed start position to a write position.

According to another embodiment of the present invention, an imaging method is provided for forming an image with an imaging apparatus that includes a motor for controlling a drive system, the method including the steps of:

activating the motor based on an imaging request signal;

controlling the start of paper feed operations and generating a paper feed operations start command signal after a predetermined time elapses from the activation of the motor; and

performing the paper feed operations based on the paper feed operations start command signal.

### BRIEF DESCRIPTION OF THE DRAWINGS

FIG. 1 is a timing chart illustrating operations of an imaging apparatus having a resist clutch;

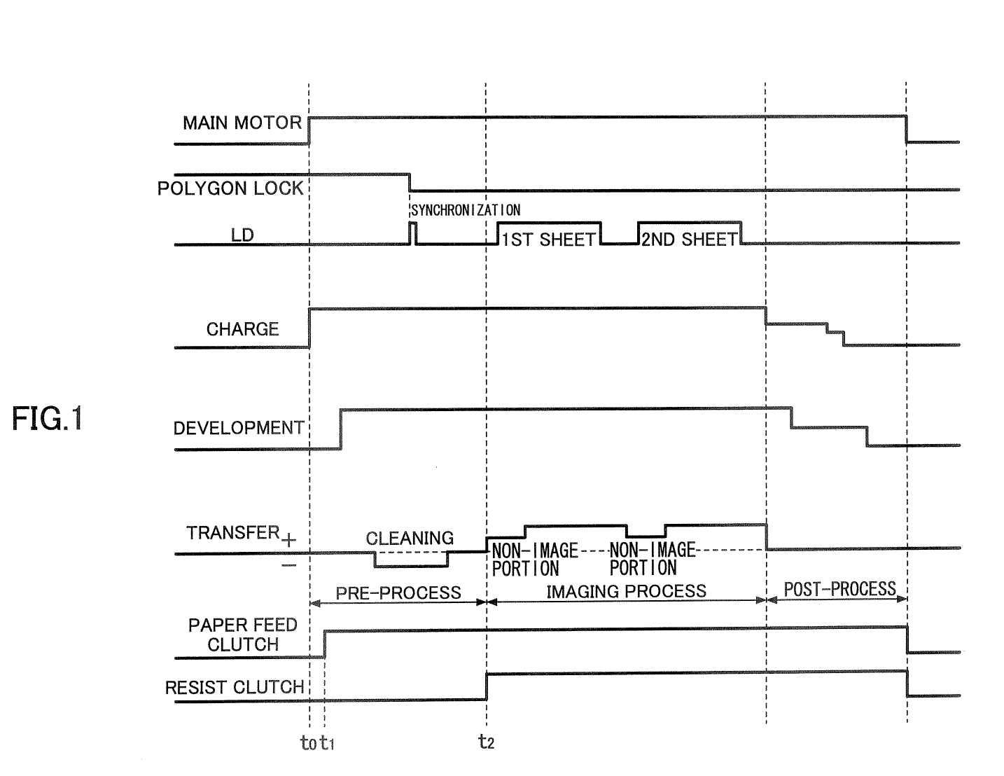

FIG. 2 is a block diagram showing a hardware configuration of a printer according to an embodiment of the present invention;

FIG. 3 is a diagram showing an internal configuration of a printer engine of the printer shown in FIG. 2;

FIG. 4 is a block diagram showing a configuration of a controller of the printer shown in FIG. 2;

FIG. 5 is a block diagram showing a functional configuration of the printer shown in FIG. 2;

FIG. 6 is a flowchart illustrating imaging operations according to a first embodiment of the present invention;

FIG. 7 is a timing chart illustrating the imaging operations according to the first embodiment;

FIG. 8 is a flowchart illustrating imaging operations according to a second embodiment of the present invention; and

FIG. 9 is a timing chart illustrating the imaging operations according to the second embodiment.

### DESCRIPTION OF THE PREFERRED EMBODIMENTS

In the following, preferred embodiments of the present invention are described with reference to the accompanying drawings.

(Imaging Apparatus)

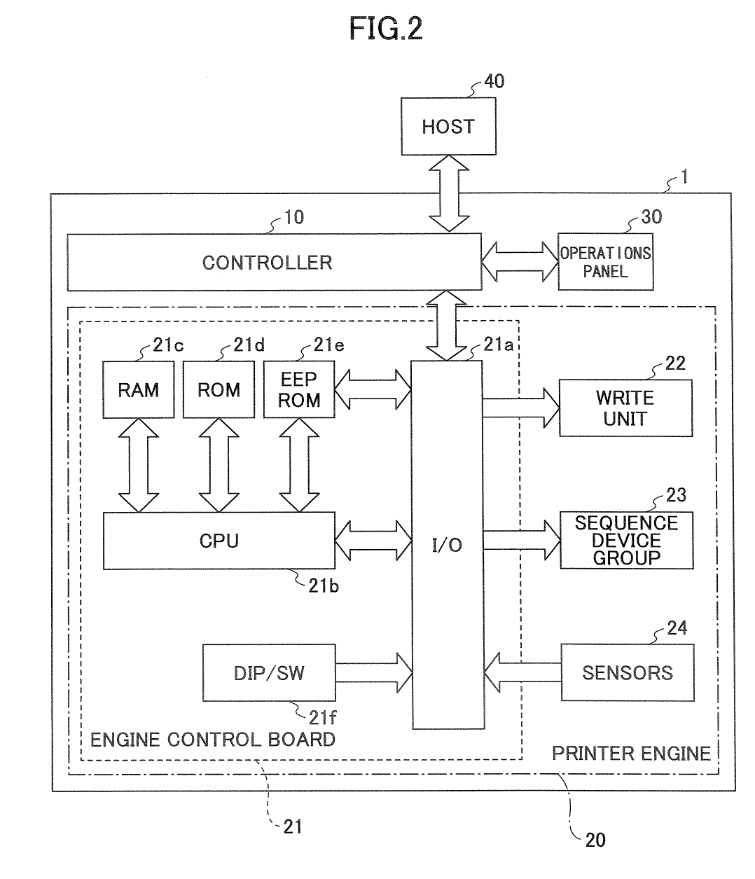

FIG. 2 is a block diagram showing an exemplary configuration of a printer as an imaging apparatus according to an embodiment of the present invention.

The illustrated printer 1 of FIG. 2 includes a controller 10, a printer engine 20, and an operations panel 30. The printer engine 20 includes an engine control board 21, a write unit 22, a sequence device group 23, and sensors 24. The engine control board 21 includes an I/O 21a as an input/output interface for the engine control board 21, a CPU (central processor unit) 21b, a RAM (random access memory) 21c, a ROM (read only memory) 21d, an EEPROM (electrically erasable and programmable ROM) 21e, and a DIP/SW 21f.

The controller 10 receives data such as a character code or a print command from an external source, performs image processing for generating depiction data, generates a signal such as a print request signal for the printer engine 20, and transmits the generated signal. For example, the controller may receive data from an external host apparatus 40.

The printer engine 20 receives a signal such as a print request signal from the controller 10 and performs imaging operations based on the received signal.

The operations panel 30 enables an operator to designate imaging modes. The operations panel 30 includes an indication unit (not shown) that indicates the status of the printer 1 and a switch unit (not shown) for switching functions such as the font or the imaging mode of the printer 1. In one example, the display unit and the switch unit of the operations panel 30 may be embodied by a liquid crystal touch panel.

The engine control board 21 controls the write unit 22, the sequence device group 23, and the sensors 24 by operating the I/O 21a, the CPU 21b, the RAM 21c, the ROM 21d, the EEPROM 21e, and the DIP/SW 21f.

The I/O 21a is an input/output interface for the engine control board 21 that enables reception/transmission f data between the controller and the operations panel 30, for example.

The CPU 21b controls overall operations of the printer engine 20 according to programs stored in the ROM 21d, mode designations made via the operations panel 30, and commands from the controller 10, for example.

The RAM 21c is used as a working memory of the CPU 21b and an input buffer for input data such as depiction data input from the controller 10.

The ROM 21d stores control programs for the printer engine 20 such as sequence control programs for a fixing system, a developing system, and a drive system.

The EEPROM 21e is a nonvolatile memory that stores information such as the error history of the printer engine 20 and mode designations made via the operations panel 30.

The DIP/SW (DIP-switch) 21f enables switching of control modes for controlling the printer engine 20. It is noted that the DIP/SW 21f does not necessarily have to be implemented and may be omitted in certain embodiments.

The write unit 22 may be a laser beam write unit that includes a laser diode and a polygon motor, for example.

The sequence device group 23 includes devices such as the fixing system, the developing system, and the drive system that are controlled by sequence control programs.

The host apparatus 40 may be a host computer that transmits/receives data to/from the printer 1, for example.

(Printer Engine)

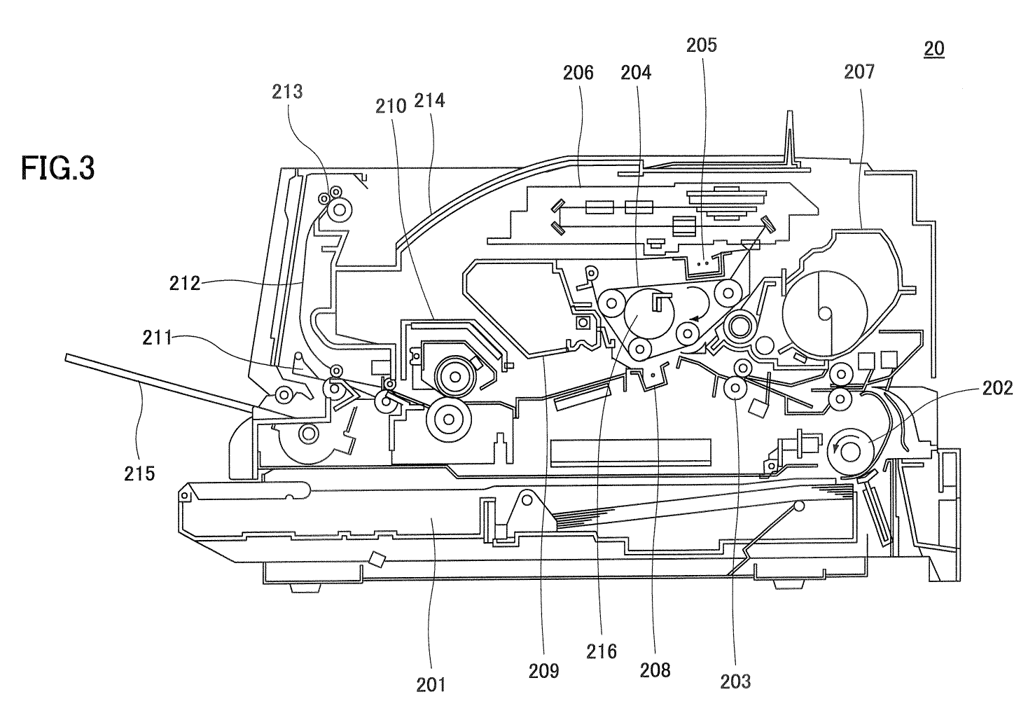

FIG. 3 is a diagram showing an exemplary internal mechanism of the printer engine 20.

In the illustrated example, the printer engine 20 includes a paper feed cassette 201, a paper feed roller 202, a pair of resist rollers 203, a photoconductor 204, a charger 205, an optical write device 206, a developing unit 207, a transfer charger 208, a cleaning device 209, a fixing device 210, a FD/FU switching solenoid member 211, a face down conveying path 212, paper delivery rollers 213, a face down paper delivery tray 214, a face up paper delivery tray 215, and a main motor 216.

The paper feed cassette 201 accommodates sheets of paper or some other printing medium, for example.

The paper feed roller 202 rotates in the direction of the arrow shown in FIG. 3 to convey a sheet of paper from the paper feed cassette 201 to the pair of resist rollers 203.

The pair of resist rollers 203 conveys the sheet of paper from the paper feed roller 202 to a write (image transfer) position at the lower section of the photoconductor 204.

The photoconductor 204 is driven in the clockwise direction as is indicated by the arrow shown in FIG. 3 and transfers an image onto paper conveyed to the write position using the charger 205, the optical write device 206, the developing unit 207, the transfer charger 208, and the cleaning device 209.

The charger 205 is configured to evenly charge the surface of the photoconductor 204.

The optical write device 206 is configured to irradiate a laser beam on the photoconductor to create a latent image on the photoconductor 204. In one preferred embodiment, the optical write device 206 may include a pixel number measuring unit.

The developing unit 207 develops a visible image with toner from the latent image formed on the photoconductor 204.

The transfer charger 208 transfers the visible image formed on the photoconductor 204 onto paper that is conveyed to the low section of the photoconductor 204 (write position).

The cleaning device 209 removes toner remaining on the photoconductor 204 after image transfer of the visible image onto paper is completed.

The fixing device 210 fixes the image transferred onto paper.

The FD/FU switching solenoid member 211 enables switching of the paper delivery tray to be used between the face down paper delivery tray 214 and the face up paper delivery tray 215.

The face down conveying path 212 conveys paper to the pair of paper delivery rollers 213 when the FD/FU switching solenoid member 211 selects use of the face down paper delivery tray 214.

The pair of paper delivery rollers 213 delivers the paper conveyed through the face down conveying path 212 to the face down paper delivery tray 214.

The face down paper delivery tray 214 accommodates sheets of paper that are delivered with recorded surfaces facing downward.

The face up paper delivery tray 215 accommodates sheets of paper that are delivered with recorded surfaces facing upward.

The main motor 216 is configured to control the drive system.

In this way, the printer engine 20 with the internal mechanism as is described above may form an image on a sheet of paper that is fed thereto and discharge the sheet with the image formed thereon.

(Controller)

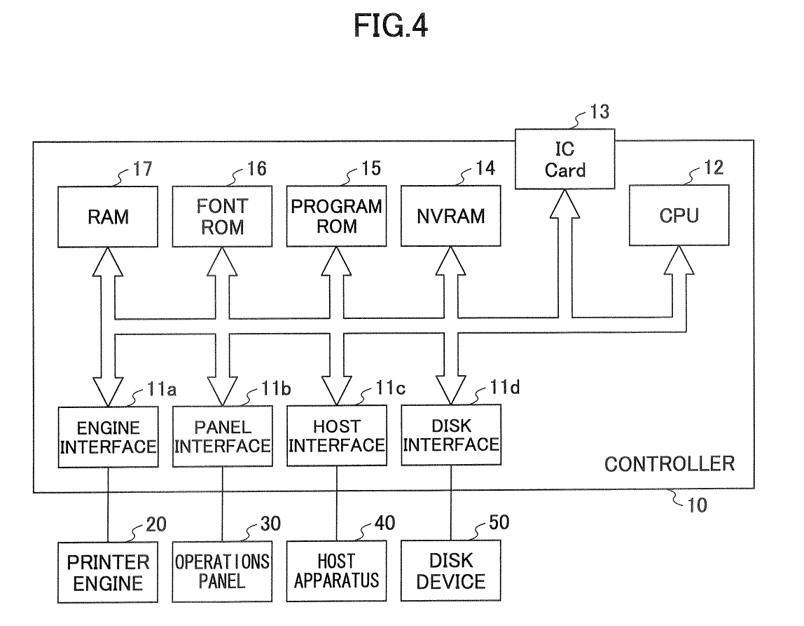

FIG. 4 is a block diagram showing an exemplary configuration of the controller 10.

In the illustrated example of FIG. 4, the controller 10 includes an engine interface 11a, a panel interface 11b, a host interface 11c, a disk interface 11d, a CPU 12, an IC card 13, a NVRAM (nonvolatile RAM) 14, a program ROM 15, a font ROM 16, and a RAM (random access memory) 17.

The engine interface 11a is used for communicating commands, status information, and print data between the controller 10 and the printer engine 20, for example.

The panel interface 11b is used for communicating commands and status information between the controller 10 and the operations panel 30.

The host interface 11c may be a Centronics or RS232C interface that is used for establishing communication between the controller and the host apparatus 40, for example.

The disk interface lid is used for establishing communication between the controller 10 and a disk device 50.

The CPU 12 performs overall control of the controller 10 according to programs stored in the program ROM 15, mode designations from the operations panel 30, and commands from the host apparatus 40, for example.

The IC card 13 is used for supplying font data and programs to the controller 10 from an external source such as the host apparatus 40.

The NVRAM 14 stores information such as that pertaining to mode designations from the operations panel 30.

The program ROM 15 stores control programs for the controller 10, for example.

The font ROM 16 stores font pattern data, for example.

The RAM 17 is used as a working memory for the CPU 12, an input buffer for input data, a page buffer for print data, and a memory for storing downloaded font data, for example.

The disk device 50 may be a floppy (registered trademark) disk device or a hard disk device that stores data including font data, programs, and print data, for example.

The controller 10 having the configuration as is described above may receive data such as a print command signal from the host apparatus 40 via the host interface 11c, perform image processes such as depiction data generation, generate a print request signal, and transmit the generated data/signal to the printer engine 20 via the engine interface 11a, for example.

(Function)

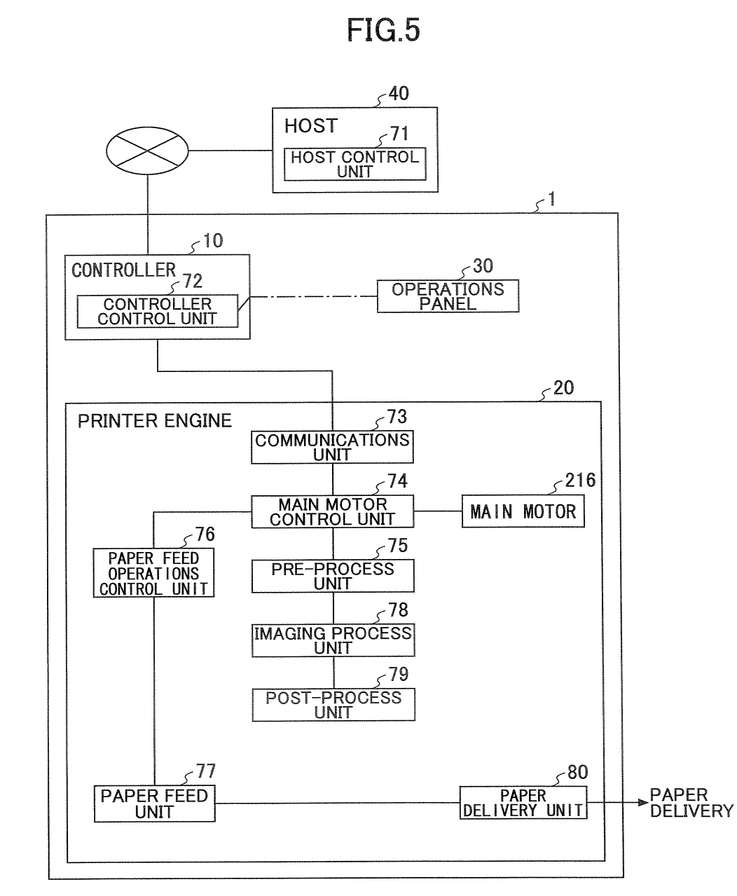

FIG. 5 is a block diagram illustrating the functions of the printer 1 according to an embodiment of the present invention. In this drawing, the printer 1 includes a controller control unit 72, a communications unit 73, a motor control unit 74, a pre-process unit 75, an imaging process unit 76, a paper feed operations control unit 77, a paper feed unit 78, a post-process unit 79, and a paper delivery unit 80.

The host apparatus 40 includes a host control unit 71 that transmits data such as character code and depiction commands to the controller 10 of the printer 1.

The controller control unit 72 receives data from the host apparatus 40, performs image processes such as depiction data generation, generates a print request signal, and transmits the generated data/signal to the printer engine 20.

The communications unit 73 transmits/receives data such as depiction data and a print request signal from the controller control unit 72 and/or data pertaining to imaging mode designations made via the operations panel 30, for example.

The motor control unit 74 controls rotation of the motor. In the present example, the motor control unit 74 starts rotation of the main motor 216 in response to a print request signal.

The pre-process unit 75 performs an imaging pre-process before an imaging process for actually transferring an image on a printing medium such as paper is started. The imaging pre-process may correspond to a so-called warm up process for the printer engine 20 that is performed from the time rotation of the main motor 216 is started until the time the imaging process for actually transferring an image on paper is started. For example, based on a print request signal, the pre-process unit 75 may perform processes such as charging, image developing, image transfer, and cleaning on the photoconductor drum 204 so that the photoconductor 204 may be ready to perform an imaging process for actually transferring an image onto paper. It is noted that the process time of the imaging pre-process may be represented by a predetermined value within 1-2 seconds that is unique to each printer, for example. Also, it is noted that a warm up process may generally connote a process performed when the power of the printer is turned on so that the printer may be ready to receive a print request; thus, in order to prevent confusion, the process for enabling the printer 1 to perform an imaging process as is described above is referred to as an imaging pre-process in the following descriptions.

The paper feed operations control unit 76 controls the paper feed unit 77 to start paper feed operations after a predetermined time elapses from the time rotation of the main motor 216 is started. In one embodiment, the predetermined time may correspond to the process time required for performing the imaging pre-process as is described above. It is noted that the paper feed operations unit 76 may be included in the motor control unit 74 according to certain embodiments.

The paper feed unit 77 starts paper feed operations upon receiving a paper feed operations start command signal from the paper feed operations control unit 76. For example, paper on which an image is to be printed may be conveyed to the lower section (write position) of the photoconductor 204 by the paper feed unit 77.

The imaging process unit 78 performs the imaging process of transferring an image onto paper. For example, the imaging process unit 78 may control the photoconductor 204 that has undergone charging, laser writing, image developing, and image transfer operations to transfer the image formed on its surface onto paper that is conveyed to the write position by the paper feed unit 77.

The post-process unit 79 performs a post-process for setting the printer engine 20 to standby mode after the imaging process of transferring an image onto paper is completed. For example, the post-process unit 79 may stop charging the photoconductor 204 and stop the rotation of the main motor 216.

The paper delivery unit 80 delivers the paper with the transferred image to a paper delivery tray. For example, the paper delivery unit 80 may deliver the paper to the face down paper delivery tray 214 or the face up paper delivery tray 215.

According to an embodiment, the host control unit 71 may send a print command signal to the controller control unit 72 of the printer 1 having the above functional configuration. Then, a print request signal issued by the controller control unit 72 or a mode designation input by an operator via the operations panel 30 may be sent to the communications unit 73 of the printer engine 20. In the printer engine 20, when the communications unit 73 receives a print request signal or a mode designation signal, the motor control unit 74, the pre-process unit 75, and the imaging process unit 78 perform processes related to image formation on paper fed by the paper feed unit 77 after which the paper delivery unit 80 delivers the image processed paper. Also, the post-process unit 79 performs a post-process for setting the printer engine 20 to standby mode.

### Embodiment 1

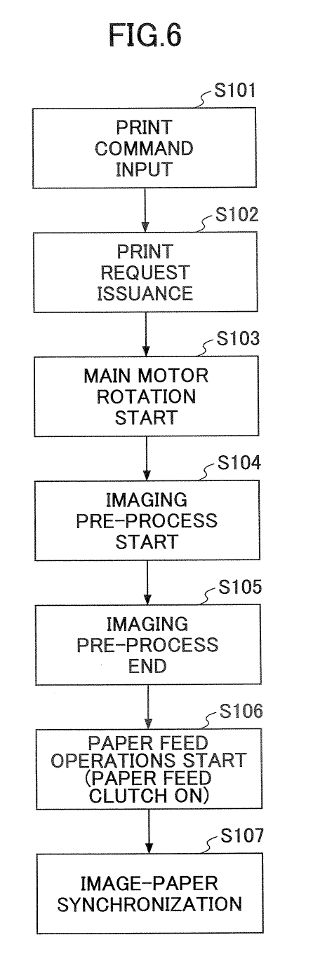

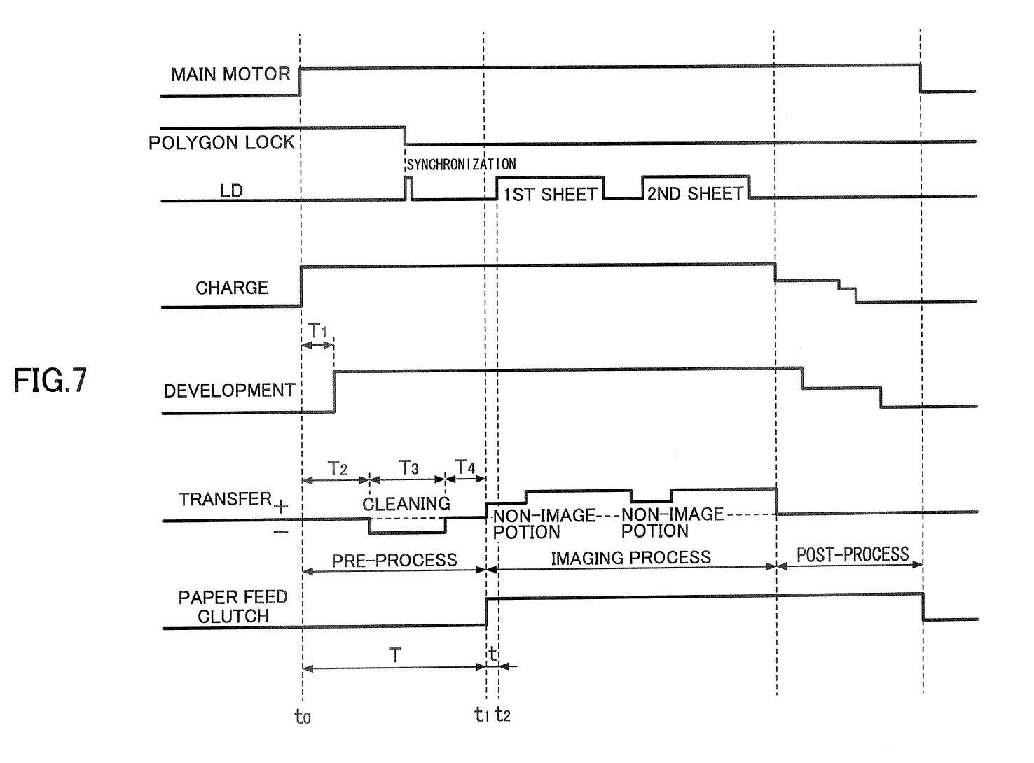

In the following, a first embodiment of the present invention is described. FIG. 6 is a flowchart and FIG. 7 is a process timing chart illustrating imaging operations according to the first embodiment. It is noted that in the imaging operations according to the present embodiment described below, paper feed operations are started when an imaging pre-process is completed in the printer 1.

In FIG. 6, first, the host control unit 71 of the host apparatus 40 outputs a print command, which is input to the controller 10 of the printer 1 (step S101).

The controller control unit 72 of the controller 10 issues a print request signal based on the input print command and transmits the issued print request signal to the printer engine 20 (step S102).

The communications unit 73 of the printer engine 20 receives the print request signal, and at time point t0 shown in FIG. 7, the motor control unit 74 of the printer engine 20 starts rotation of the main motor 216 (step S103). At this point, a main motor phase as is illustrated in FIG. 7 is switched from low (L) to high (H).

Also, the pre-process unit 75 of the printer engine 20 starts an imaging pre-process (step S104). In the imaging pre-process, drive operations of the photoconductor drum 204 are started. The charger 205 starts charging the photoconductor 204 so that a charge phase as is illustrated in FIG. 7 is switched from low (L) to high (H). Then, after the elapse of time period T1, the developing unit 207 that is subject to sequence processing may be able to generate a visible image with toner from a latent image formed on the surface of the photoconductor 204. At this point, a development phase as is illustrated in FIG. 7 is switched from low (L) to high (H). However, since operations are still in the pre-process stage, no latent image is formed on the photoconductor 204. After the elapse of time period T2, the cleaning device 209 that is subject to sequence control may perform a toner removal process for one circulation of the photoconductor drum 204, for example. In this case, a cleaning phase as is illustrated in FIG. 7 is set negative (−). Then, after the elapse of time period T4, namely, at time point t1, the imaging pre-process is ended (step S105). At this point, the printer engine 20 may be ready to start an imaging process involving transfer or an image onto paper. It is noted that the process time required for the imaging pre-process is expressed as T=T2+T3+T4 in the present example, and its value may be within a range of 1-2 seconds that may be unique to each printer.

After the imaging pre-process is completed, the paper feed operations control unit 76 of the printer engine 20 turns on a paper clutch making up the paper feed unit 77, and controls the paper feed roller 202 to start paper feed operations (step S106). In the present example, the paper feed operations control unit 76 controls the paper feed unit 77 to start paper feed operations at time point t1, namely, after the predetermined time period T (i.e., process time required for the imaging pre-process) elapses from time point t0 at which rotation of the main motor 216 is started. At this point, a paper feed clutch phase as is illustrated in FIG. 7 is switched from low (L) to high (H). It is noted that step S105 of ending the imaging pre-process and step S106 of starting the paper feed operations (i.e., turning on the paper feed clutch) are both executed at time point t1. That is, the paper feed operations are started when the imaging pre-process is ended.

When the paper feed operations are started in step S106, paper from the paper feed cassette 201 passes the paper feed roller 202 and the pair of resist rollers to be conveyed to the lower section of the photoconductor 204 (write position) It is noted that in FIG. 7, the time required for paper to be conveyed from the paper feed start position to the write position is expressed as time period t (time point t1 to time point t2). At time point t2, the optical write unit 206 starts write (image transfer) operations of the photoconductor drum 204, and image-paper synchronization is performed a the write position (step S107).

After step S107, the imaging process unit 78 transfers an image onto paper, and the post-process unit 79 performs a post-process for setting the printer engine 20 to standby mode. Also, the paper delivery unit 80 discharges the paper with the transferred image.

In the present embodiment, it is assumed that a polygon motor reaches a steady rotation before the imaging pre-process is ended in step S105. Thus, a polygon lock phase as is illustrated in FIG. 7 is switched from high (H) to low (L) during the time the imaging pre-process is performed.

As can be appreciated from the above descriptions, in the first embodiment of the present invention, paper feed operations are started when the imaging pre-process is ended, and image-paper synchronization is performed at the write position so that an imaging process may be accurately performed. According to an aspect of the present invention, paper feed operations may be controlled to start at the time an imaging process is started by means of a simple configuration so that the time required for obtaining a first print may be reduced. According to another aspect of the present embodiment, paper feed operations do not have to be temporarily halted at a resist position and a resist clutch does not have to be provided in order to obtain a quick first print so that manufacturing costs may be reduced.

### Second Embodiment

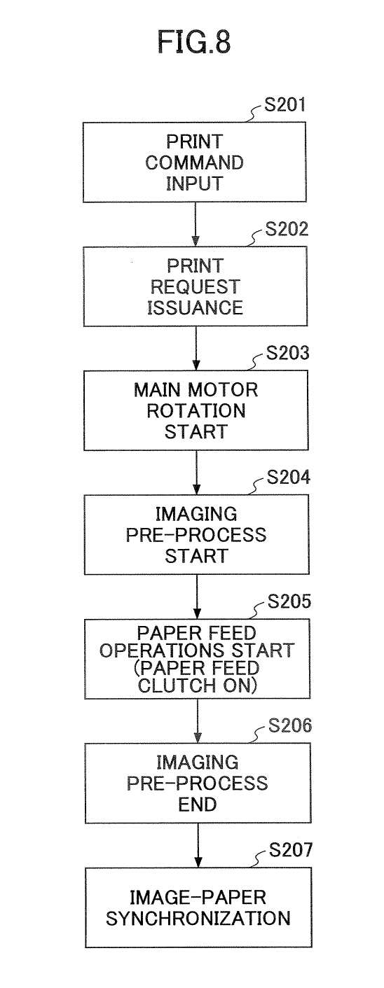

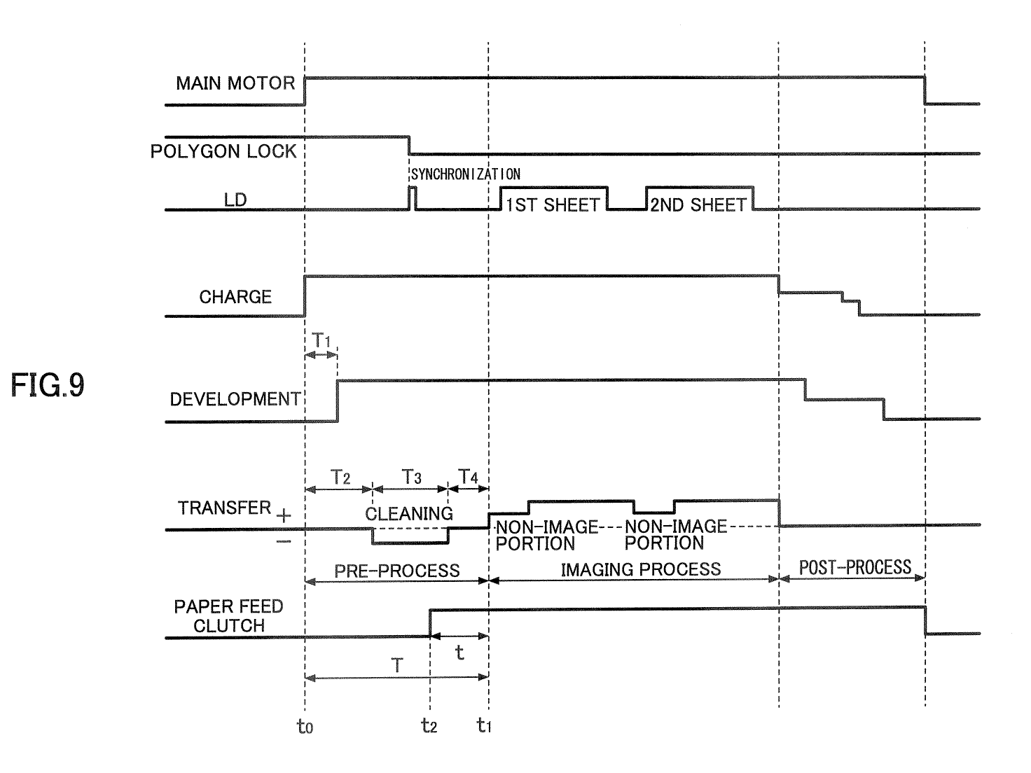

In the following, a second embodiment of the present invention is described. FIG. 8 is a flowchart and FIG. 9 is a process timing chart illustrating imaging operations according to the second embodiment. It is noted that in the imaging operations according to the present embodiment described below, the time it takes for paper to be conveyed from the paper feed start position to the write position (paper conveying time) and the process time of the imaging pre-process are taken into account, paper feed operations are started before the imaging pre-process is ended so that an imaging process may be ready at the time paper is conveyed to the write position.

In FIG. 8, first, the host control unit 71 of the host apparatus 40 outputs a print command signal, which is input to the controller 10 of the printer 1 (step S201).

The controller control unit 72 of the controller 10 generates a print request signal based on the input print command and sends the generated print request signal to the printer engine 20 (step S202).

The communications unit 73 of the printer engine 20 receives the generated print request signal, and at time point t0, the motor control unit 74 of the printer engine 20 starts rotation of the main motor 216 (step S203). At this point, a main motor phase as is illustrated in FIG. 9 is switched from low (L) to high (H).

Also, the pre-process unit 75 of the printer engine 20 starts an imaging pre-process (step S204). It is noted that processes to be performed in the imaging pre-process are similar to those described in relation to the first embodiment, and thereby, such descriptions are omitted.

Then, at time point t2 of FIG. 9, the paper feed operations control unit 76 of the printer engine 20 turns on the paper feed clutch making up the paper feed unit 77 to start conveying paper to the paper feed roller 202 (step S205). At this point, a paper clutch phase as is illustrated in FIG. 9 is switched from low (L) to high (H). It is noted that in the present embodiment, the step of starting the paper feed operations (step S205) is performed after a predetermined time period (i.e., time point t0 to time point t1) elapses from the time the imaging pre-process is started, the predetermined time period being obtained by subtracting the time it takes for paper to be conveyed from the paper feed start position to the write position (i.e., time point t2 to time point t1, denoted as paper conveying time t) from the process time of the imaging pre-process (time period T).

Then, at time point t1, namely, after time period t elapses from time point t2, the imaging pre-process is ended (step S206). That is, at time point t1, the time period T corresponding to the process time of the imaging pre-process elapses from time point t0 at which the imaging pre-process is started. Also, at this point, the paper that starts to be conveyed in step S205 passes the paper feed roller 202 and the pair of resist rollers 203 to reach the lower section of the photoconductor 204 (write position).

Then, the optical write unit 206 starts write operations of the photoconductor 204, and image-paper synchronization is performed at the write position (step S207).

After step S207, the imaging process unit 78 performs an imaging process for transferring an image onto paper. Then, the post-process unit 79 performs a post-process for setting the printer engine 20 to standby mode. Also, the paper delivery unit 80 discharges the paper with the transferred image.

As can be appreciated from the above descriptions, in the present embodiment, the paper conveying time for conveying paper from the paper feed start position to the write position and the process time of the imaging pre-process are taken into account, and paper feed operations are started (step S205) before the imaging pre-process is ended (steoS206) so that the imaging process may be ready at the time paper is conveyed to the write position. According to an aspect of the present embodiment, paper feed operations may be controlled by means of a simple configuration in a manner such that paper is conveyed to the write position at the time an imaging process is started, and the time required for obtaining a first print may be further reduced by time t with respect to the first embodiment.

In the present embodiment, it is assumed that a polygon motor reaches a steady rotation before the imaging pre-process is ended in step S206. Accordingly, a polygon lock phase as is illustrated in FIG. 9 is switched from high (H) to low (L) during the time the imaging pre-process is performed (i.e., between time points t0 and t1).

Although the present invention is shown and described with respect to certain preferred embodiments, it is obvious that equivalents and modifications may occur to others skilled in the art upon reading and understanding the specification. The present invention includes all such equivalents and modifications, and is limited only by the scope of the claims.

The present application is based on and claims the benefit of the earlier filing date of Japanese Patent Application No. 2006-071782 filed on Mar. 15, 2006, the entire contents of which are hereby incorporated by reference.

What is claimed is:

1. An imaging apparatus comprising:
a motor that controls a drive system;
a motor control unit that activates the motor based on an imaging request signal;
a paper feed operations control unit that controls paper feed operations to start after a predetermined time period elapses from the activation of the motor; and
a paper feed unit that performs the paper feed operations based on a paper feed operations start command signal from the paper feed operations control unit.

2. The imaging apparatus as claimed in claim 1, wherein
the predetermined time period corresponds to a time period required for starting an imaging process after the activation of the motor.

3. The imaging apparatus as claimed in claim 1, wherein
the predetermined time period corresponds to a subtracted time period obtained by subtracting a paper conveying time period from a time period required for starting an imaging process after the activation of the motor, the paper conveying time period being a required time period for conveying paper from a paper feed start position to a write position.

4. An imaging method for forming an image with an imaging apparatus that includes a motor for controlling a drive system, the method comprising the steps of:
activating the motor based on an imaging request signal;
controlling a start of paper feed operations and generating a paper feed operations start command signal after a predetermined time elapses from the activation of the motor; and
performing the paper feed operations based on the paper feed operations start command signal.
